(19) United States
(12) Patent Application Publication
(10) Pub. No.: US 2012/0133119 A1
(43) Pub. Date: May 31, 2012

(54) EXPANDING FILE WITH INDEXING FUNCTIONS

(75) Inventor: Chun-Ning TSENG, Rende Township (TW)

(73) Assignee: SMART FORTUNE INTERNATIONAL LIMITED, Taichung City (TW)

(21) Appl. No.: 12/955,075

(22) Filed: Nov. 29, 2010

(51) Int. Cl. B42F 21/00

(52) U.S. Cl. 283/36

(57) ABSTRACT

An organ pack record binder with indexing functions having a main body, an indexing tab inserting portion and an indexing tab. The indexing tab has a snapping portion, which is arranged transversely and inserted into the indexing tab inserting portion. A lateral flange is formed at one side of the snapping portion. A protruding portion is formed by the extension of the lateral flange of its snapping portion to define a first and a second end. The first end is linked to the snapping portion's lateral flange. An identifier is linked to the second end of the protruding portion. The identifier is protruded to realize visible classification and indexing effect of the organ pack record binder, thus improving the indexing effect and convenience of the organ pack record binder.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to an organ pack record binder, and more particularly to an innovative one which allows its indexing tab to be fitted with an identifier for visible classification and indexing purposes.

2. Description of Related Art

Including Information Disclosed Under 37 CFR 1.97 and 37 CFR 1.98.

There are a variety of “loose-leaf binders” in the stationery market, which are used to accommodate files and papers in an orderly manner. Yet, a currently available multi-fold loose-leaf binder is generally fitted with a plurality of spacers, among which a space is formed for accommodating files.

But, it is inconvenient to open the space separately for searching a specific file in the loose-leaf binder. For the aforementioned issues, an indexing tab has been developed to improve the applicability of the loose-leaf binder. Letters can be underlined on the indexing tab, which may be a rectangular plate; and a slot for the indexing tab is set on the top of the loose-leaf binder's spacer to improve the convenience in searching files.

However, in spite of the fact that conventional indexing tab could address the aforementioned problems, the fast-growing customer demands cannot be met due to its simple appearance, and the indexing effect is insufficient if only letters are underlined for searching purposes.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production, development and design of related products.

### BRIEF SUMMARY OF THE INVENTION

The enhanced efficacy of the present invention is as follows:

The “organ pack record binder” of the present invention is mainly characterized by that, the indexing tab inserted into the indexing tab inserting portion of the main body includes a snapping portion, a protruding portion and an identifier, so the identifier could be used to provide visible classification and indexing effect, helping to improve the indexing function and convenience of the organ pack record binder.

Based on the innovative configuration wherein a novel identifier is protruded from the indexing tab, the innovative indexing tab could attract the attention of the users, and improve the value and competitive power of the product for better industrial and economic benefits.

The improvements brought about by this invention are as follows:

Based on the structural pattern wherein a prefolding line is set at the joint of the protruding portion and snapping portion, the protruding portion and identifier can be folded along the prefolding line correspondingly with the snapping portion, allowing to cover the organ pack record binder with a cover plate.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a perspective view of the organ pack record binder of the present invention.

FIG. 2 is a schematic view of the assembly of the indexing tab and indexing tab inserting portion of the present invention.

FIG. 3 is a schematic view of the assembly of the indexing tab and indexing tab inserting portion of the present invention.

FIG. 4 is a schematic view of the present invention wherein the indexing tab is in a folding state.

FIG. 5 is an example diagram of the present invention wherein the indexing tab is available with writing functions.

### DETAILED DESCRIPTION OF THE INVENTION

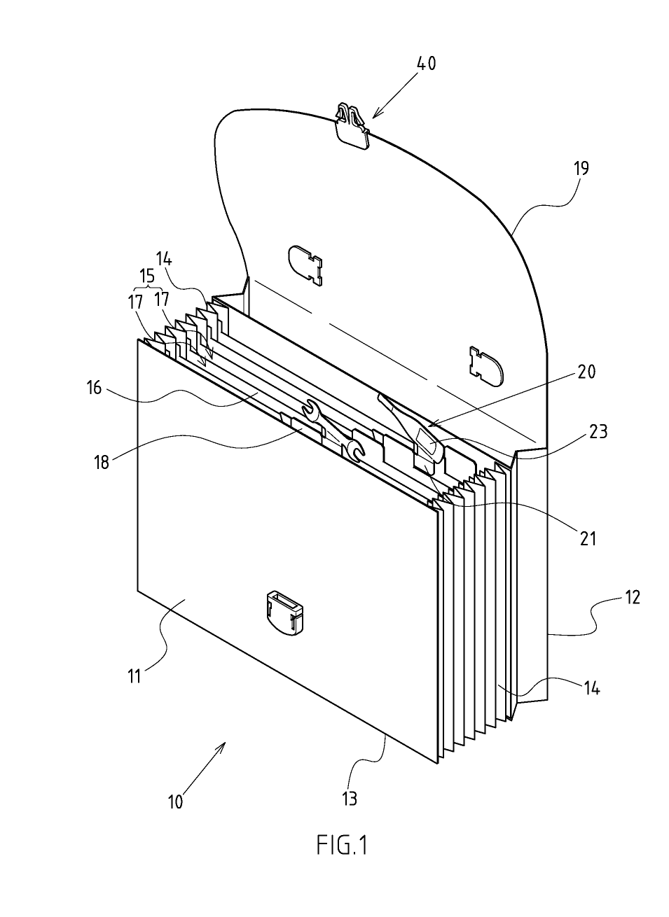

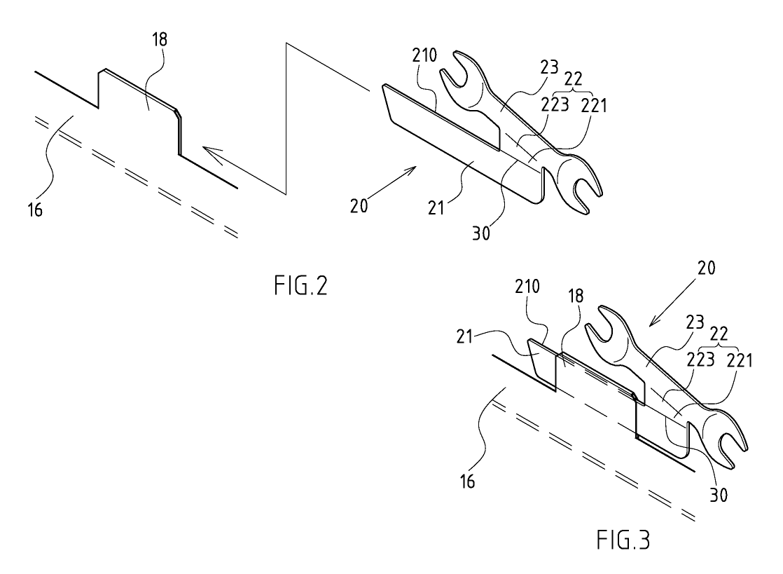

FIGS. 1-3 depict preferred embodiments of an organ pack record binder of the present invention with indexing functions, which, however, are provided for only explanatory objective for patent claims. Said organ pack record binder includes a main body 10, at least consisting of a front panel 11, a rear panel 12 and a base plate 13 arranged at interval, as well as two side sheets 14 with V-shaped corrugated surfaces and an inner space 15 set between the front and rear panels 11, 12. Of which the inner space 15 permits a plurality of spacers 16 to separate itself into several holding spaces 17.

An indexing tab inserting portion 18 is exposed on the top of the spacer 16. The indexing tab inserting portions 18 for the spacer 16 are misaligned.

An indexing tab 20 is inserted into the indexing tab inserting portion 18 of the main body 10. The indexing tab 20 includes a snapping portion 21, arranged transversely, and inserted into the indexing tab inserting portion 18. A lateral flange 210 is formed on one side of the snapping portion 21.

A protruding portion 22 is formed by the extension of the lateral flange 210 of its snapping portion 21 to define a first end 221 and a second end 223. Of which the first end 221 is linked to the lateral flange 210 of the snapping portion 21.

An identifier 23 is linked to the second end 223 of the protruding portion 22, enabling the indexing tab 20 to realize visible classification and indexing effects.

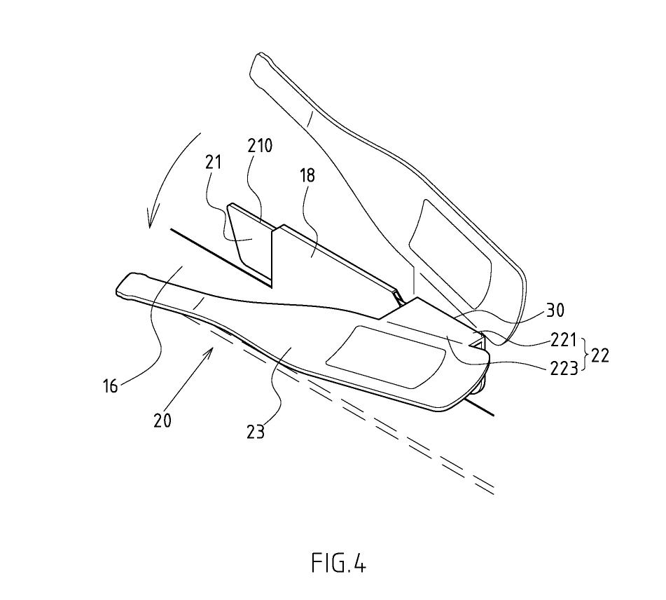

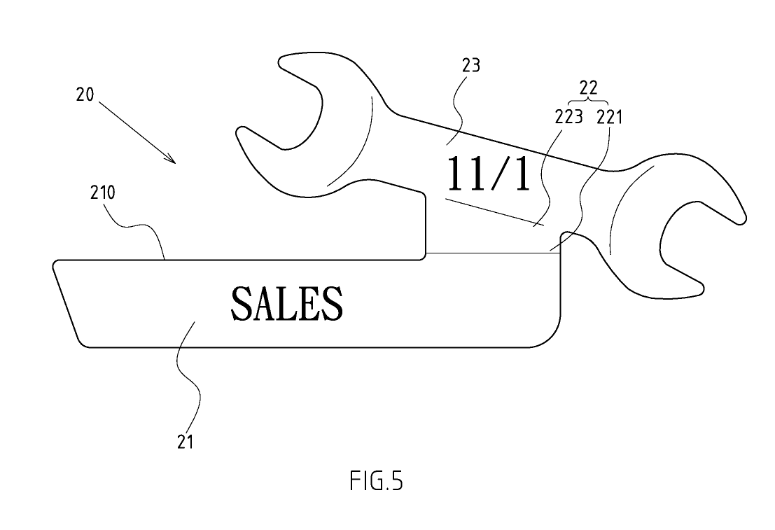

Referring to FIG. 4, a prefolding line 30 is set at the joint of the protruding portion 22 and snapping portion 21, so that the protruding portion 22 and identifier 23 can be folded along the prefolding line 30 correspondingly with the snapping portion 21, allowing to cover the organ pack record binder with a cover plate 19.

Of which, a cover plate 19 (marked in FIG. 1) is extended from the top of the rear panel 12. The cover plate 19 and front panel 11 permit a locator 40 to position the top of the inner space 15.

Referring to FIG. 5, the indexing tab 20 with writing functions enables the users to mark the classified items or prompts for an improved indexing effect.

Based on above-specified structural configuration, the core of the organ pack record binder of the present invention lies in that, the main body 10 is provided with an indexing tab inserting portion 18 for insertion of the indexing tab 20. The indexing tab 20 includes a snapping portion 21, a protruding portion 22 and identifier 23. As the snapping portion 21 is inserted into the indexing tab inserting portion 18, the identifier 23 is located higher than the indexing tab inserting portion 18, enabling visible classification and indexing of the organ pack record binder, and also alleviating the work burden with the vivid appearance of the identifier 23. The identifier 23 can be designed into any shape, as shown in FIGS. 4, 5, wherein the identifier 23 is designed separately into the shape of bottle and spanner, so a novel indexing tab 20 is created to meet diversified user demands with improved indexing functions.

1. An organ pack record binder with indexing function comprising:
a main body having a front panel, a rear panel and a base plate arranged at interval, as well as two side sheets with V-shaped corrugated surfaces and an inner space set between the front and rear panels; of which the inner space permits a plurality of spacers to separate itself into several holding spaces;
an indexing tab inserting portion exposed on the top of the spacer, the indexing tab inserting portions for the spacer being misaligned; and
an indexing tab inserted into the indexing tab inserting portion of the main body, the indexing tab comprising:
a snapping portion arranged transversely and inserted into the indexing tab inserting portion; a lateral flange is formed on one side of the snapping portion;
a protruding portion formed by the extension of the lateral flange of its snapping portion to define a first and second end; of which the first end is linked to the lateral flange of the snapping portion; and
an identifier linked to the second end of the protruding portion.

2. The structure defined in claim 1, wherein a prefolding line is set at the joint of the protruding portion and snapping portion, so that the protruding portion and identifier can be folded along the prefolding line correspondingly with the snapping portion.

3. The structure defined in claim 1, wherein a cover plate is extended from the top of the rear panel; the cover plate and front panel permit a locator to position the top of the inner space.

4. The structure defined in claim 1, wherein the indexing tab is available with writing functions.
